(19) United States
(12) Patent Application Publication
(10) Pub. No.: US 2026/0008490 A1
(43) Pub. Date: Jan. 8, 2026

(54) Convertible Stroller with Integrated Changing table

(71) Applicant: Jourdan Quibodeaux, Duson, LA (US)

(72) Inventor: Jourdan Quibodeaux, Duson, LA (US)

(21) Appl. No.: 19/259,190

(22) Filed: Jul. 3, 2025

Related U.S. Application Data
(60) Provisional application No. 63/667,565, filed on Jul. 3, 2024.

(51) Int. Cl. B62B 9/12; A47D 5/00; B62B 9/20

(52) U.S. Cl. CPC B62B 9/12; A47D 5/006; B62B 9/20

(57) ABSTRACT

A stroller which may be transformed into a safe, efficient, and private child changing table. A handlebar assembly having a spring-loaded pull-tab mechanism allows the handlebar to be folded forward over the stroller canopy and locks in a horizontal position to serve as the support base for the changing table. The changing table is stored in a rear compartment behind the seat and attaches securely to the handlebar when deployed. Fold-down support legs extend from the frame to enhance stability, and retractable privacy panels stored within the changing table enclose the changing area, along with the canopy. A built-in five-point harness secures the child, allowing the child to remain seated until the changing table is fully deployed. The changing table can be cleaned and stowed in the rear storage compartment. When not in the changing configuration, the stroller operates in its normal configuration without alteration

### CROSS-REFERENCE TO RELATED APPLICATIONS

This application claims the benefit of U.S. Provisional Patent Application No. 63/667,565, filed on Jul. 3, 2024, which is incorporated herein by reference in its entirety.

### FIELD OF INVENTION

The present subject matter relates generally to infant transportation devices and, more particularly, to a mobile convertible infant care stroller system configured to transition into an integrated diaper changing station while maintaining portability, structural integrity, and ease of use for caregivers in mobile settings.

### BACKGROUND OF THE INVENTION

Changing an infant's diaper at home typically occurs in a controlled environment, often utilizing a dedicated changing table. Such home changing tables generally provide a stable and personal surface, frequently equipped with shallow side walls or contoured pads to mitigate the risk of the infant rolling off. However, these home-based solutions inherently lack portability and often do not integrate storage for essential diaper changing supplies, necessitating separate organization of items such as diapers, wipes, and ointments.

Conversely, changing an infant's diaper outside the home presents a distinct set of challenges, often resulting in inconvenient, unhygienic, or unsafe circumstances. Public changing facilities, commonly found in restrooms, are typically constructed from hard, non-porous materials and are utilized by numerous individuals. This shared usage raises significant hygienic concerns, as the cleanliness and sanitation of these surfaces cannot be consistently assured, thereby increasing the potential for germ exposure and cross-contamination for infants. Furthermore, the public nature of these facilities may compromise privacy for both the caregiver and the child. Instances of misuse or inadequate maintenance of public changing stations further exacerbate these concerns.

In situations where dedicated public facilities are unavailable, caregivers often resort to improvised solutions, such as changing an infant on a vehicle's interior surfaces or on their lap. While offering a degree of immediate accessibility, these methods introduce substantial safety and hygienic risks. Changing an infant within a vehicle can create an enclosed, awkward space, potentially limiting the caregiver's situational awareness and reaction time to external threats or unforeseen circumstances. Moreover, performing a diaper change in public, particularly with the caregiver's back turned, can leave both the caregiver and the infant vulnerable to security risks, such as theft or assault. This vulnerability is particularly pronounced for single caregivers who lack the immediate support of another adult to maintain vigilance. Additionally, improvised surfaces, even with the use of a towel or mat, may not adequately prevent germ transfer or contain messes effectively.

Existing portable changing mats or surfaces, while offering some degree of portability, are typically flat fabric pieces that provide minimal comfort or structural support for the infant. Their design often fails to adequately prevent an infant from rolling off, posing a safety hazard. Conventional diaper bags are primarily designed for the transport and storage of supplies, and while some may include a basic changing pad, they do not inherently provide a stable, elevated, or hygienic changing table. This often requires caregivers to duplicate supplies or risk forgetting essential items when transitioning between home and mobile settings.

Furthermore, attempts to integrate diaper changing capabilities into infant transportation devices, such as strollers, have frequently introduced their own limitations. These designs often necessitate complex, multi-step deployment procedures, may require the infant to be removed from the stroller prior to conversion, or fail to achieve a truly stable and secure changing platform. Issues related to the effective containment and isolation of messes, as well as the provision of adequate privacy during public use, remain largely unaddressed in much of the existing art.

Therefore, there is a persistent and unmet need for a convertible infant transportation device that seamlessly integrates a structurally sound, hygienic, and private changing station. Such a device must be capable of rapid, intuitive deployment, ideally with minimal effort, while ensuring the safety and cleanliness of the infant in diverse mobile environments.

The present invention is intended to satisfy the aforementioned needs by providing a convertible stroller system configured to transition into an integrated private and sanitary diaper changing station while maintaining portability, structural integrity, and ease of use for caregivers in mobile settings.

The field of infant transportation devices and portable changing systems has seen various attempts to integrate multi-functional features into strollers. While efforts have been made to address caregiver convenience, existing solutions often present significant limitations, particularly concerning ease of use, stability, hygiene, and privacy in diverse environments.

For instance, U.S. Pat. No. 8,480,114 B1, discloses a stroller with fold-out changing table components. However, this design typically requires the parent to perform a series of complex movements and actions to deploy the changing table, precluding one-handed operation. Furthermore, the child must often be removed from the stroller before the table can be fully prepared. The changing table's reliance on a hinge at its midpoint for support can result in a less stable base compared to integrated frame elements. This configuration inherently results in a less stable and potentially flexible changing table, as it lacks integration with the primary load-bearing elements of the stroller frame. Crucially, this invention does not provide features for ensuring privacy during diaper changes, nor does it address the critical concern of preventing cross-contamination, as its changing table components are not easily separable or independently storable for hygienic purposes.

Another approach is seen in U.S. Pat. No. 9,668,589 B2, which describes a portable changing table designed for attachment to a stroller. This solution necessitates removing the child from the stroller before attachment and requires the parent to manage multiple connectors, adding complexity to its setup. Being primarily fabric-based, this invention offers limited preventative measures against messes and potential germ retention, and its reliance on straps for support may not provide a perfectly level or consistently stable changing table over time, as materials can stretch. Privacy measures are absent from this design. As used herein, the term “changing table” refers to the primary support component that forms the horizontal diaper-changing area when deployed, whether rigid or semi-rigid in construction.

U.S. Patent App. Pub. No. US 2018/0168364 A1, introduces a baby-changing table apparatus attachable to a stroller. While aiming for adaptability, this design often requires the parent to remove the stroller seat from its mounting bracket and then insert the changing table, creating multiple steps that reduce overall convenience. This invention, too, lacks provisions for privacy and does not specify mechanisms for locking wheels, which could compromise stability during use.

U.S. Pat. No. 7,618,055 B2, describes a convertible stroller to a diaper-changing station that emerges from under the seat. However, deploying the changing table from this position results in a significantly low and potentially strenuous height for the parent to access the child. This design also omits features for ensuring privacy and does not adequately address the issue of containing or isolating messes to prevent the spread of germs to the stroller's main fabric and sensitive areas. The low and potentially awkward changing position can also leave parents and children vulnerable in public settings.

U.S. Pat. No. 7,798,516 B2, details a changing table apparatus secured to the back of a baby carriage. While it deploys from the back, it notably lacks any dedicated measures for privacy. Concerns about hygiene persist as it does not provide for a removable changing table that can be cleaned separately to prevent germ spread. Moreover, while claiming to support a child's weight, the absence of specific support mechanisms like extendable legs suggests a potential lack of robust stability.

U.S. Pat. No. 11,820,416 B1, presents an articulating stroller platform that allows the seat and backrest to adjust to a horizontal position for diaper changing, along with privacy panels. However, this design typically involves folding the backrest backward, which may restrict space or comfort for the child when the stroller is in its standard configuration. The mechanisms employed, particularly the pull straps for the privacy panels, appear to serve primarily as a flexible connection rather than a robust, integrated structural component. The privacy panels themselves are depicted as simple side-hanging sheets, which may lack the integrated and structurally supportive nature of other, more comprehensive privacy solutions.

These patents, therefore, generally fall short in providing a comprehensive, hygienic, and convenient solution for mobile diaper changing. Therefore, there is a need for a systems that provides ease of one-handed deployment, allows the child to remain in the seat during initial setup, provides adequate stability, privacy, and sanitation features, and notably, does not rely on the main structural components of the stroller for a robust changing table support. Thus, there is also a need for a convertible stroller system that seamlessly integrates a structurally sound, hygienic, and private changing station that is operable with minimal effort while maintaining the stroller's primary functionality and compact form factor.

### SUMMARY OF THE INVENTION

The present invention discloses a convertible stroller system having a handlebar assembly configured to transition into a horizontally positioned private and sanitary diaper changing station while maintaining portability, structural integrity, and ease of use for caregivers in mobile settings.

Once the handlebar assembly is positioned horizontally, a detachable changing table may be retrieved from a rear storage compartment and secured onto the handlebar assembly via a fastening mechanism, such as magnetic or latch points. Upon deployment of the changing table, in one embodiment, integrated support mechanisms may extend from the handlebar assembly and lock onto the stroller base, providing robust structural support and enhanced stability for the changing table. The changing table is further equipped with a child safety belt or fastening mechanism to secure the infant during diaper changes.

The changing table is a tri-fold mat that includes deployable privacy panels. These privacy panels are integrated into the folding structure of the changing table and automatically unfurl or extend when the changing table is deployed, providing lateral privacy. Upon completion of the diaper change, the caregiver may refold the changing table, causing the privacy panel to retract.

For hygienic management, the changing table may be returned to the rear storage compartment if clean. Alternatively, if soiled, it may be temporarily secured beneath the storage basket area and the stroller's base via fastening mechanisms, such as magnets, until it can be cleaned at a later time. This dual storage capability ensures a clean and personal changing table for each use and prevents cross-contamination with the main stroller components.

After the changing table is stowed, the caregiver may retract the handlebar assembly back into its traditional upright stroller position, allowing the family to continue their activities with minimal interruption.

An objective of the present invention is to provide a stroller having a stroller frame system that can be converted into a fully functional diaper changing station with significantly greater ease and efficiency, ideally in a single-handed motion, without requiring removal of the child from the stroller prior to set up.

Another objective is to increase hygiene and privacy for caregivers performing diaper changes in public spaces by offering a deployable, self-contained solution that eliminates reliance on unsanitary public fixtures.

A further objective is to maintain traditional stroller functionality, portability, and compact foldability while introducing structural innovations that do not interfere with the stroller's day-to-day use.

### BRIEF DESCRIPTION OF THE DRAWINGS

The accompanying drawings illustrate various views of the preferred embodiment of the present invention. In such drawings:

FIG. 1 is a perspective view of the stroller pull tab mechanism according to one embodiment of the present invention,

FIG. 1A is a top view of the stroller pull tab mechanism of FIG. 1.

FIG. 1B is a partial detail view of the locking pin of the stroller pull tab mechanism of FIG. 1.

FIG. 1C is a cross-section view of the stroller pull tab mechanism cut along section line A-A of FIG. 1A.

FIG. 1D is a side view of the pull tab of the stroller pull tab mechanism shown in FIG. 1.

FIG. 2 shows schematic views of the stroller frame assembly of the convertible stroller in a transitional configuration, showing the pull tab mechanism engaged and the folding push bar pivoted forward into a horizontal, locked position to function as a support of a changing table.

FIG. 3 shows schematic views of the stroller frame assembly shown in FIG. 2 of the convertible stroller of applicant's invention shown in various operational positions of the detachable changing table, showing both its retracted and deployed configurations as integrated with the stroller frame.

FIG. 4 shows sequential schematic views of the stroller frame assembly shown in FIG. 2 of the convertible stroller system of applicant's invention illustrating privacy panels that are attached to the detachable changing table in both retracted and deployed positions, with collapsible support legs extending and locking into position against the lower frame via hand stops to provide added stability during use.

FIG. 5 shows a schematic rear perspective view of the stroller frame assembly shown in FIG. 2 of the convertible stroller system of applicant's invention.

FIG. 6 shows a schematic side of a convertible stroller system employing the stroller frame assembly of the convertible stroller shown in FIG. 2 with the support legs of the handlebar deployed.

FIG. 7 shows a perspective view of an embodiment of the convertible stroller of applicant's invention.

FIG. 8 shows a partial perspective view of the embodiment of the convertible stroller of applicant's invention shown in FIG. 7 illustrating the changing table and the privacy features in a deployed position.

### DETAILED DESCRIPTION OF THE DRAWINGS

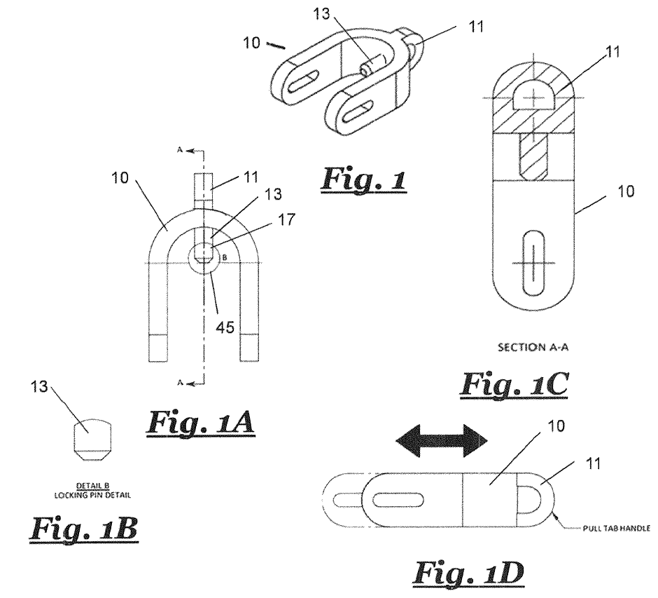

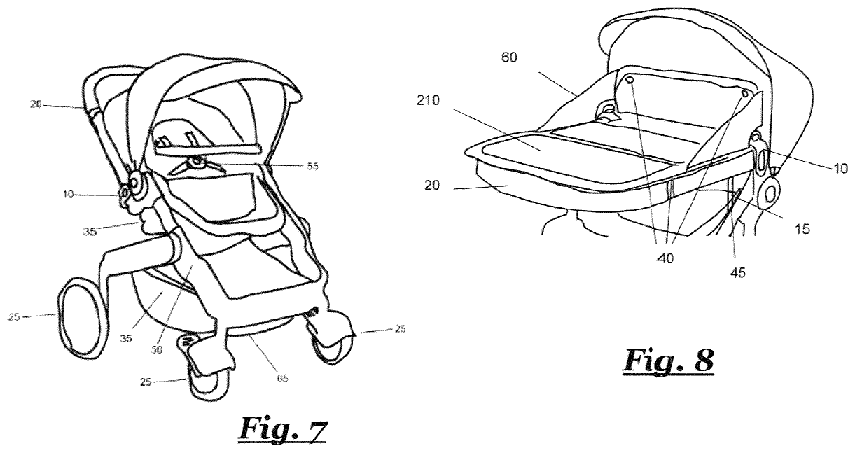

The present invention, as illustrated in FIGS. 1 through 8, pertains to a convertible stroller assembly 80 having a frame assembly 101 with a handlebar mechanism 20 designed to seamlessly transition into a functional and structurally support surface 18 for a changing table 210. The invention is intended for use in both public and private settings. The handlebar mechanism 20 incorporates the integrated fold-over handlebar 21 of the handlebar mechanism 20 and may include at least one extendable support mechanism 15 integrated with the handlebar mechanism 20 that enhance the utility and stability of the device during its alternate use as a changing station. The disclosed convertible stroller assembly 80 improves upon conventional stroller systems by introducing a streamlined transformation mechanism and space-saving folding elements, thereby meeting the practical needs of mobile infant transportation devices with infants and toddlers.

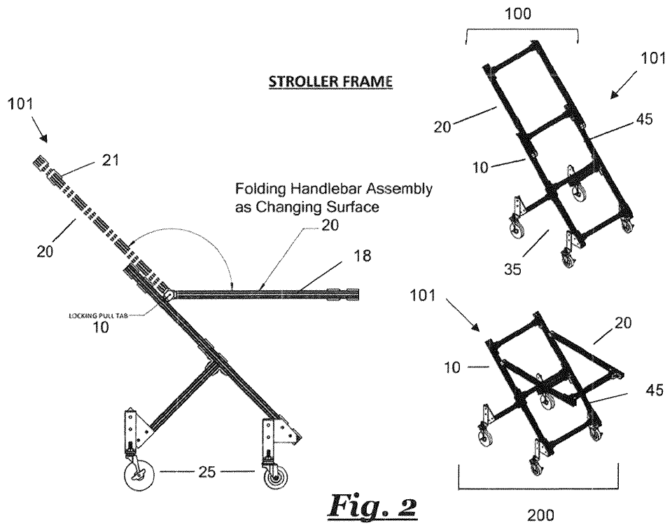

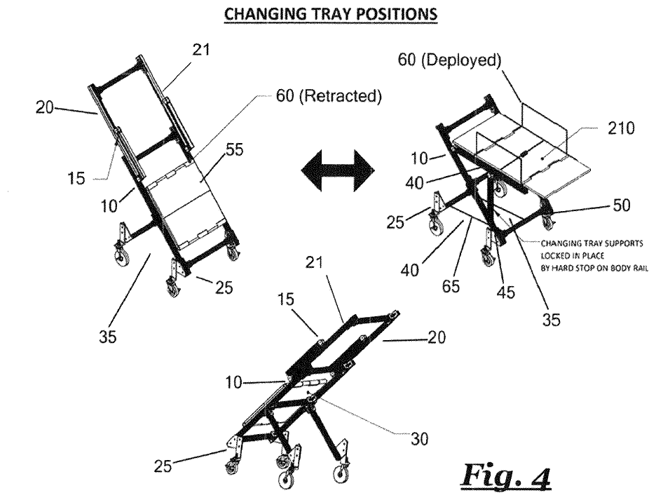

Referring to FIG. 1, there is shown the pull-tab mechanism 10, a key component of the handlebar system 20, that is utilized for engaging and deploying the convertible handlebar system 20. FIGS. 1A-1D illustrate multiple views of the pull-tab mechanism 10. This mechanism 10 is integral to the stroller frame assembly 101 (which is part of the overall traditional stroller configuration 100, as well as the changing table configuration 200 shown in FIG. 2) and its lower frame or base platform, serving as the primary load-bearing structure of the stroller. Constructed of lightweight, rigid material such as injection-molded polymer, aluminum tubing, or a composite structural resin, this base platform 45 features multiple mounting points which accommodate wheel assemblies, leg attachments, and support hardware. The handlebar assembly 20, which is part of the frame elements generally indicated by 20 in FIGS. 2, 3, and 4, is operably coupled to the frame base platform 45 via a locking hinge mechanism that may be selectively deployed or retained in place by actuation of the pull-tab mechanism 10. A cross-sectional view of the pull-tab mechanism is shown in Section A-A of FIG. 1, illustrating the internal spring and pin configuration. Additionally, Detail B in FIG. 1 shows an enlarged view of the locking pin element used to secure the handlebar during use. This mechanism allows the handlebar to transition rotationally from an upright pushing orientation to a horizontal, support-enhancing configuration during changing table use. This rotation is facilitated by a spring-loaded pull-tab mechanism, labeled as 10 in FIG. 1 and FIG. 2, integrated into each side of the handlebar's hinge joint. The handlebar assembly 20, when folded, rests horizontally atop the stroller frame and acts as a load-distributing crossbeam beneath the infant during diaper changes. The embodiment, in FIG. 4, with the telescoping portion of the handlebar includes a guided rod featuring detent positions that engage when the handlebar is in its horizontal orientation. This mechanism provides additional structural reinforcement during use of the changing table, minimizing flex and lateral movement.

In its primary stroller configuration, the invention includes a typical four-wheel arrangement composed of front and rear locking wheels, generally indicated by 25 in FIGS. 2, 3, and 4. These wheels are secured to the platform's wheel mounts by axles embedded in pivot sockets to allow for maneuverability. All wheel components may be manufactured from thermoplastic rubber, polyurethane, or any other suitable material to ensure durability, shock absorption, and quiet operation. The stroller further features a seat enclosure, preferably fabricated from durable, washable materials such as nylon or polyester. These materials are selected for their suitability in environments requiring frequent cleaning and are considered advantageous in minimizing microbial retention and enhancing user hygiene, affixed to the platform via integrated frame hooks and stabilized by safety straps. The seat enclosure is further outfitted with a built-in five-point safety harness configured to secure the infant during use in the strolling function.

The unique transformation feature, illustrated in greater detail in FIG. 2, is initiated through the user's engagement with the aforementioned pull-tab mechanism 10 shown in FIGS. 1-4D. The user pulls the handlebar tabs 11 outward, disengaging locking pins 13 from their recessed housings 17 within the platform base 45, which allows the handlebar 21 of the handlebar assembly 20 to pivot forward and down until it reaches a locked horizontal position shown in FIG. 2. In this configuration, the handlebar 21 provides lateral stability and frontal support, effectively converting the stroller into a changing table surface. The locking pins 13 automatically re-engage upon full extension, ensuring secure use in this alternate configuration.

To further stabilize the changing table during this conversion, the present invention incorporates an embodiment where a pair of extendable support legs, explicitly labeled as 15 in FIGS. 2, 3, and 4. The extendable support legs 15 are stored within recessed compartments along a surface of the handlebar assembly 20, said surface facing up when the stroller is in an upright strolling configuration and facing horizontally downward when the handlebar assembly 20 is deployed in a changing table configuration. These support legs 15 are stopped within compartments along or within the lower edges of the base platform 45. The support legs 15 are constructed from anodized aluminum or equivalent rigid tubular material and may include a telescoping feature with friction locks or ball-pin stops, not shown, to adjust for uneven terrain.

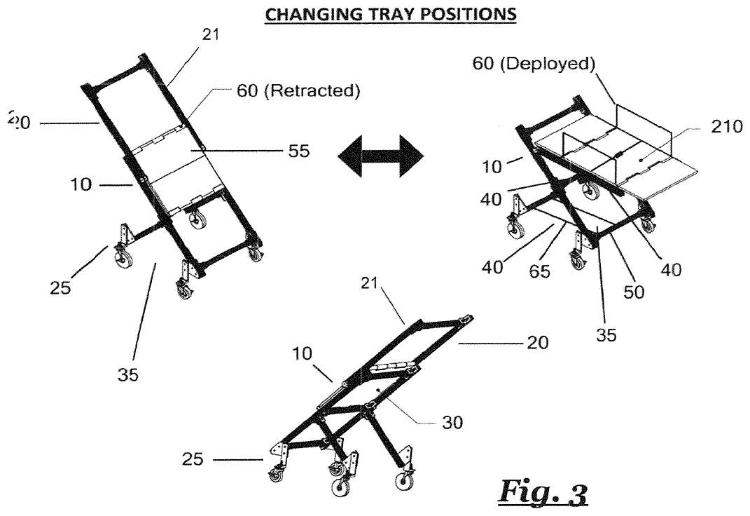

FIG. 4 depicts the stroller frame assembly 101 in mid-transition between configurations, with the handlebar assembly 20 partially folded forward and the support mechanisms 15 beginning their downward extension. In this view, the underside of the handlebar assembly 20 reveals changing table supports 15, which offer additional mechanical and structural support when the stroller is used as a changing table. The changing table 210, a tri-fold mat or otherwise, is outfitted with attachment support mechanisms 40, such as magnets or other brace fasteners (identified in FIGS. 3 and 4) that serve as a preferred stabilizing mechanism for the deployed changing table. These braces are designed to lock into structural hard stops along the handlebar assembly 20, thereby significantly enhancing load distribution and structural rigidity during changing operations. The changing table itself is shown stored in a rear storage compartment as 30 in FIGS. 3 and 4.

The changing table 210 is further stabilized by an assembly that includes changing table attachment support mechanisms 40 and multiple folding support elements, as demonstrated by the changing table's 210 tri-fold or otherwise configuration, which provides room for changing to be performed. The changing table 210 support mechanisms 15 are integrated into the underside of the stroller assembly 20 and pivot downward when the stroller is in changing table mode. This assembly 20 rotates along a fixed hinge axis and is configured to lock into a perpendicular orientation relative to the stroller base, thereby providing additional rearward structural support beneath the changing table. Once engaged, the assembly 20 creates a buttressing effect against the lower chassis, helping distribute vertical load forces applied during diaper changes.

Integrated into this handlebar assembly 20 are a pair of attachment support mechanisms, labeled 40 in FIGS. 3 and 4. These attachment support mechanisms 40 are stored on either side of the handlebar assembly 20. When deployed, the attachment support mechanisms 15 lock in place by a hard stop or detent mechanism, not shown, integrated into the base platform 45 of the stroller frame, forming a rigid triangular support geometry that enhances lateral and vertical stability. The attachment support mechanisms 15 may collapse inward and fold flush against the frame when not in use, allowing the entire assembly to remain compact during transport or stroller operation.

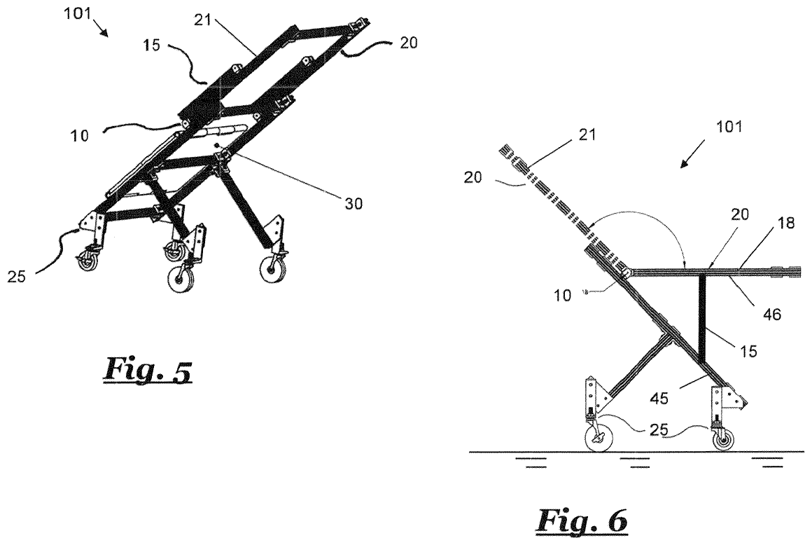

Additional support is provided by changing table supports 15, shown more clearly in FIGS. 5 and 6, which are stowed along the underside of the push bar or handlebar assembly 20. These supports pivot outward and downward into a diagonal orientation when the changing table 210 is unfolded into its usable changing configuration. Once extended, the supports 15 stop into structural guide channels 46 formed along the underside of the handlebar 21 of the handlebar assembly 20 of the stroller frame, preventing vertical deflection of the changing table under load. The user may retract these supports manually when collapsing the changing table, at which point the supports return to a folded position.

Together, the surface support mechanisms 15, stop points 46, and the attachment support mechanisms 40 create a multi-point stabilization system that reinforces the horizontal surface during changing operations while remaining unobtrusive during stroller use. These elements are configured to deploy in a coordinated sequence as part of the same folding motion, minimizing the number of steps required by the caregiver and ensuring intuitive usability.

The changing table 210 in usable position, shown within dimension line 200 in FIG. 1 and further seen in FIGS. 3 and 4, is secured atop the handlebar frame 45 and supported by attachment support mechanism 40 having support legs 15 to form a stable diaper changing area. This changing table 210 can be secured, not only to the handlebar assembly 20 by means of attachment support mechanisms 40, as well as, but not limited to a hook-and-loop fastener or snap fasteners, that operate within the same means of the attachment support mechanisms 40. The changing table 210 can be stored in an integrated compartment 65 located underneath the storage basket 35 on a support 50 on stroller base 45. The changing table 210 is generally constructed of a soft, wipe-clean surface such as polyurethane laminate (PUL) or medical-grade vinyl, and optionally may include stretch edges to wrap around the sides of the platform during use. When not deployed, the changing table 210 retracts neatly within its housing, reducing bulk and maintaining the stroller's streamlined aesthetic. The changing table 210 in usable positions is further shown in FIGS. 3 and 4.

Privacy panels 60 are integrated into the folding structure of the changing table 210 to provide lateral privacy during diaper changes in public or shared environments. As shown in FIGS. 3 and 4, the privacy panels 60 are stowed within designated interior folds or compartments of the tri-fold changing table 210 when in its collapsed configuration. When the changing table 210 is removed from the rear storage compartment 30 and placed onto the horizontal handlebar assembly 20, it is unfolded into a flat, usable position. During this unfolding process, the privacy panels 60 are simultaneously deployed from within the side sections of the changing table.

In one embodiment, each privacy panel 60 comprises a thin, flexible textile sheet formed of polyester, nylon, or other washable, lightweight material. These panels are affixed to the underside or edge seams of the folding sections of the changing table 210 and are automatically unfurled or released as the structure is opened. When fully deployed, the privacy panels 60 extend out and downward from the lateral edges of the changing table to form vertical curtains or shields that hang adjacent to the stroller frame. The panels 60 are dimensioned to provide coverage along both sides of the child during changing, enhancing discretion and comfort for the caregiver, and partnering with the canopy of the stroller to function as a 3-way privacy shield.

What is claimed is:

1. A convertible stroller apparatus comprising:
a. a main frame;
b. a seating surface integrated into said main frame;
c. a foldable handlebar mechanism pivotally connected to said main frame, said handlebar mechanism adapted to receive a changing table; and
d. wherein said foldable handlebar mechanism is configured to transition to a generally horizontal position, whereby said handlebar mechanism serves as a support for said changing table.

2. The convertible stroller apparatus recited in claim 1 wherein:
a. said foldable handlebar mechanism includes a spring-loaded pull tab mechanism configured to disengage a locking pin from a recessed housing within a hinge joint of said main frame; and
b. wherein engagement of said pull tab mechanism enables said handlebar mechanism to pivot forward into a locked horizontal position.

3. The convertible stroller apparatus recited in claim 2 wherein with a single hand wherein said pull-tab mechanism is manually engaged by a user.

4. The convertible stroller apparatus recited in claim 3, further comprising at least one deployable support leg configured to extend vertically downward from said horizontal foldable handlebar mechanism.

5. The convertible stroller apparatus recited in claim 4, wherein said foldable handlebar mechanism is configured to rotate and lock into a horizontal position, thereby forming a support structure for said changing table, and wherein said changing table is adapted to be positioned on and secured to said horizontal handlebar position.

6. The convertible stroller apparatus recited in claim 5, wherein said changing table is a tri-fold changing table stowable upon said main frame.

7. The convertible stroller apparatus recited in claim 6, wherein said tri-fold changing table is removably secured to said main frame via hook-and-loop fasteners and is constructed from a washable, waterproof material suitable for infant contact.

8. The convertible stroller apparatus recited in claim 7, further comprising at least one storage compartment positioned beneath said seating surface on said main frame for containment of changing supplies.

9. The convertible stroller apparatus recited in claim 8 wherein, said support leg is telescoping to enable height adjustment.

10. The convertible stroller apparatus recited in claim 9, further comprising a wheel assembly mounted to the bottom of said main frame, said wheel assembly including pivoting and locking capabilities to allow for transport and immobilization.

11. The convertible stroller apparatus recited in claim 10, wherein said telescoping support leg includes a guided rod with multiple detent positions configured to lock said telescoping support leg in an extended position.

12. The convertible stroller apparatus recited in claim 11, wherein said main frame is constructed from a lightweight, impact-resistant material selected from the group consisting of reinforced polymers, metal alloys, or composite tubing.

13. The convertible stroller apparatus recited in claim 12, wherein said frame includes a retractable latching system configured to secure the apparatus in the stroller configuration or the changing table configuration during use.

14. The convertible stroller apparatus recited in claim 13, further comprising deployable privacy panels integrated with at least one of a canopy or side folds of the stroller, said privacy panels configured to enclose a changing area when the apparatus is in the changing table configuration.
